(19) United States
(12) Patent Application Publication
(10) Pub. No.: US 2019/0318352 A1
(43) Pub. Date: Oct. 17, 2019

(54) Wireless Digital Payment For Vehicles

(71) Applicant: Ford Global Technologies, LLC, Dearborn, MI (US)

(72) Inventors: Karl Nathan Clark, Belleville, MI (US); Xin Ye, Farmington Hills, MI (US); Eric Williams, Clinton Twp., MI (US); Satish Rayarapu, Canton, MI (US)

(21) Appl. No.: 15/952,385

(22) Filed: Apr. 13, 2018

(51) Int. Cl. G06Q 20/38; G06Q 20/40; G06Q 20/32; G07C 5/00

(52) U.S. Cl. CPC G06Q 20/3823; G06Q 20/38215; G06Q 20/4012; G06Q 2220/00; G06Q 20/325; G07C 5/008; G06Q 20/40145

(57) ABSTRACT

A vehicle system comprises a processor programmed to responsive to a successful authentication of a user, launch a payment application and establish a wireless communication with a payment terminal; exchange a security certificate with the payment terminal; and authorize a transaction by transmitting transaction information including ECU information to the payment terminal.

### TECHNICAL FIELD

The present disclosure is generally related to a wireless payment system. More specifically, the present disclosure is related to a wireless payment system for vehicles.

### BACKGROUND

There are many wireless payment services that are currently available (e.g. Apple Pay®, and Google Pay®). However, most of them are not designed for vehicles. For instance, when a vehicle pulls up to a drive through outlet (e.g. McDonald® drive through) and makes a purchase, the payment process still requires the user or driver to fetch his/her electronic device such as a cell phone and put it near a wireless card reader to perform the transaction. This may be inconvenient in some cases.

### SUMMARY

In one or more embodiments of the present disclosure, a vehicle system comprises a processor programmed to responsive to a successful authentication of a user, launch a payment application and establish a wireless communication with a payment terminal; exchange a security certificate with the payment terminal; and authorize a transaction by transmitting transaction information including ECU information to the payment terminal.

In one or more embodiments of the present disclosure, a payment terminal comprises a processor programmed to establish a wireless connection to a digital entity responsive to a successful authentication of a user on the digital entity; exchange security certificate with the digital entity; receive a payment authorization including an ECU signature from the digital entity; send the payment authorization to a server; and receive an approval from the server.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 illustrates an example block topology of a vehicle payment system of one embodiment of the present disclosure;

FIG. 2 illustrates an example flow diagram for wireless payment of one embodiment of the present disclosure; and

FIG. 3 illustrates an example data flow diagram for the wireless payment of one embodiment of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present disclosure generally provides for a plurality of circuits or other electrical devices. All references to the circuits and other electrical devices, and the functionality provided by each, are not intended to be limited to encompassing only what is illustrated and described herein. While particular labels may be assigned to the various circuits or other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programed to perform any number of the functions as disclosed.

The present disclosure, among other things, proposes a vehicle wireless payment system. More specifically, the present disclosure proposes a vehicle wireless payment system that requires user authentication and vehicle identification as a security feature. Further aspects of the disclosure are discussed in detail herein.

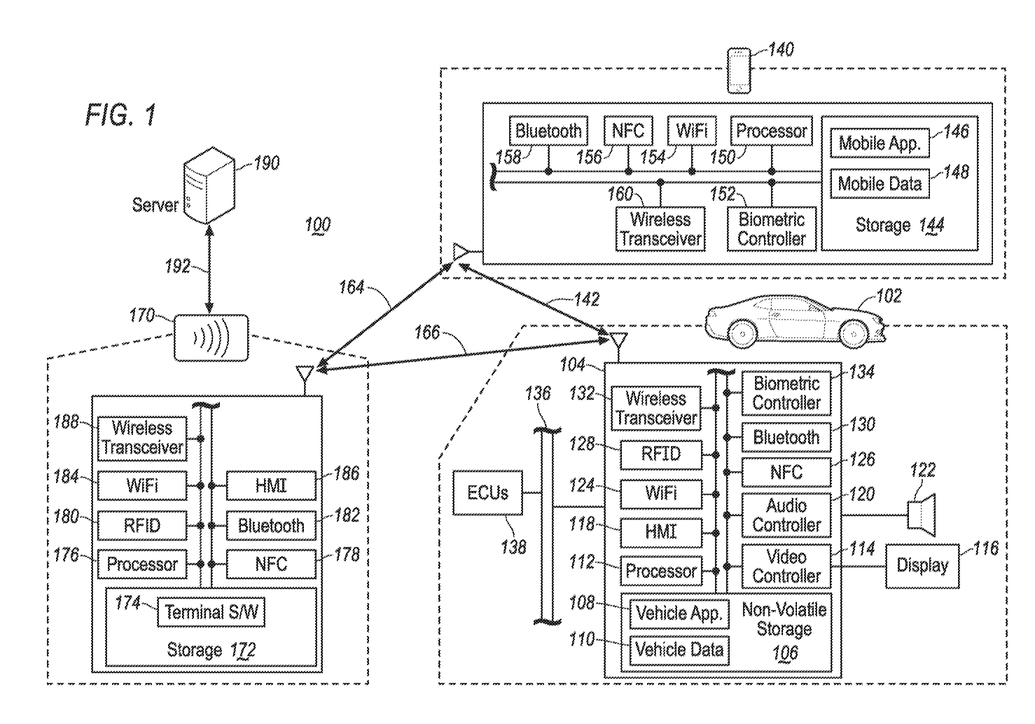

Referring to FIG. 1, an example block topology of a vehicle wireless payment system 100 of one embodiment of the present disclosure is illustrated. The vehicle charging system 100 may generally include a vehicle 102, a mobile device 140 associated with the vehicle 102, and a payment terminal 170. It should be noted that the illustrated system 100 is merely an example, and more, fewer, and/or differently located elements may be used.

The vehicle 102 may include various types of automobile, crossover utility vehicle (CUV), sport utility vehicle (SUV), truck, recreational vehicle (RV), boat, plane, or other mobile machine for transporting people or goods. In many cases, the vehicle 102 may be powered by an electric motor. As another possibility, the vehicle 102 may be a hybrid electric vehicle (HEV) powered by both an internal combustion engine and one or move electric motors, such as a series hybrid electric vehicle (SHEV), a parallel hybrid electric vehicle (PHEV), or a parallel/series hybrid vehicle (PSHEV), a boat, a plane or other mobile machine for transporting people or goods. As an example, the vehicle 102 may include the SYNC system manufactured by The Ford Motor Company of Dearborn, Michigan.

As illustrated in FIG. 1, a computing platform 104 of the vehicle 102 may include one or more processors 112 configured to perform instructions, commands, and other routines in support of the processes described herein. For instance, the computing platform 104 may be configured to execute instructions of vehicle applications 108 to provide features such as navigation, satellite radio decoding, and wireless payment. Such instructions and other data may be maintained in a non-volatile manner using a variety of types of computer-readable storage medium 106. The computer-readable medium 106 (also referred to as a processor-readable medium or storage) includes any non-transitory medium (e.g., tangible medium) that participates in providing instructions or other data that may be read by the processor 112 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants/users to interface with the computing platform 104. For example, the computing platform 104 may receive input from human-machine interface (HMI) controls 118 configured to provide for occupant interaction with the vehicle 102. As an example, the computing platform 104 may interface with one or more buttons (not shown) or other HMI controls (e.g., steering wheel audio buttons, a push-to-talk button, instrument panel controls, etc.) configured to invoke functions on the computing platform 104 as well as other components of the vehicle 102.

The computing platform 104 may also drive or otherwise communicate with one or more displays 116 configured to provide visual output to vehicle occupants by way of a video controller 114. In some cases, the display 116 may be a touch screen further configured to receive user touch input via the video controller 114, while in other cases the display 116 may be a display only, without touch input capabilities. The computing platform 104 may also drive or otherwise communicate with one or more speakers 122 configured to provide audio output to vehicle occupants by way of an audio controller 120.

The computing platform 104 may be provided with a biometric controller 134 configured to process biometric information of a user such as fingerprint and facial recognition using sensors such as a fingerprint reader and a camera (not shown). The biometric information collected through the biometric controller 134 may be processed by the processor 112 using compatible vehicle applications 108 and stored in the storage 106 as a part of the vehicle data 110. Alternatively, the biometric information may be stored on a separate device (not shown) such as an encrypted security chip for extra security.

The computing platform 104 may be further configured to communicate with a plurality of electronic control units (ECUs) 138 via one or more in-vehicle network 136. The in-vehicle network 136 may include, but is not limited to, one or more of a controller area network (CAN), an Ethernet network, and a media oriented system transport (MOST), as some examples. As a few non-limiting examples, the ECUs 138 may include an engine control module (ECM), a powertrain control module (PCM), a telematic control unit (TCU), and a body control module (BCM) (not shown). For instance, each ECU 138 has an unique serial number which may be used for security authentication purposes.

The computing platform 104 may be configured to communicate with a mobile device 140 of the vehicle user via a wireless connection 142. The mobile device 140 may be any of various types of portable computing device, such as cellular phones, tablet computers, smart watches, laptop computers, portable music players, or other device capable of communication with the computing platform 104. In many examples, the computing platform 104 may include a wireless transceiver 132 in communication with a WiFi controller 124, a near-field communication (NFC) controller 126, a radio-frequency identification (RFID) controller 128, a Bluetooth controller 130, and other controllers such as a Zigbee transceiver, an IrDA transceiver (not shown), configured to communicate with a compatible wireless transceiver 158 of the mobile device 140.

The mobile device 140 may be provided with a processor 150 configured to perform instructions, commands, and other routines in support of the processes such as calling, wireless communication, multi-media processing and digital transaction processing. The mobile device 140 may include a wireless transceiver 160 in communication with a WiFi controller 154, a NFC controller 156, a Bluetooth controller 158, and other controllers configured to communicate with the compatible wireless transceiver 132 of the computing platform 104.

The mobile device 140 may be provided with a biometric controller 152 configured to process biometric information of a user such as fingerprint and facial recognition using sensors such as a fingerprint reader and a camera (not shown). The biometric information collected through the biometric controller 152 may be processed by the processor 150 using compatible mobile applications 146 and stored in the storage 144 as a part of the mobile data 148.

The computing platform 104 may be configured to communicate with a wireless payment terminal 170 (also referred to as payment terminal or terminal) via a wireless connection 166. The wireless payment terminal 170 may include one or more processors 176 configured to perform instructions, commands, and other routines in support of the processes described herein. As an example, the wireless payment terminal 170 may be configured to execute instructions of terminal software 174 stored in a storage 172 to provide functions such as wireless communication, and processing payment with various digital entities. The charging station 160 may be provided with HMI controls 186 configured to provide interaction with an operator.

The wireless payment terminal 170 may include a wireless transceiver 188 in communication with a NFC controller 178, a RFID controller 180, a Bluetooth controller 182, a WiFi controller and other controllers configured to communicate with a compatible wireless transceiver such as the wireless transceiver 132 of the vehicle 102. Additionally or alternatively, the wireless transceiver 188 may be configured to communicate with the wireless transceiver 160 of the mobile device 140 via a wireless connection 164. The wireless payment terminal 170 may further connected to a server 190 via a connection 192, which may be a wired or wireless connected used to process payment transactions.

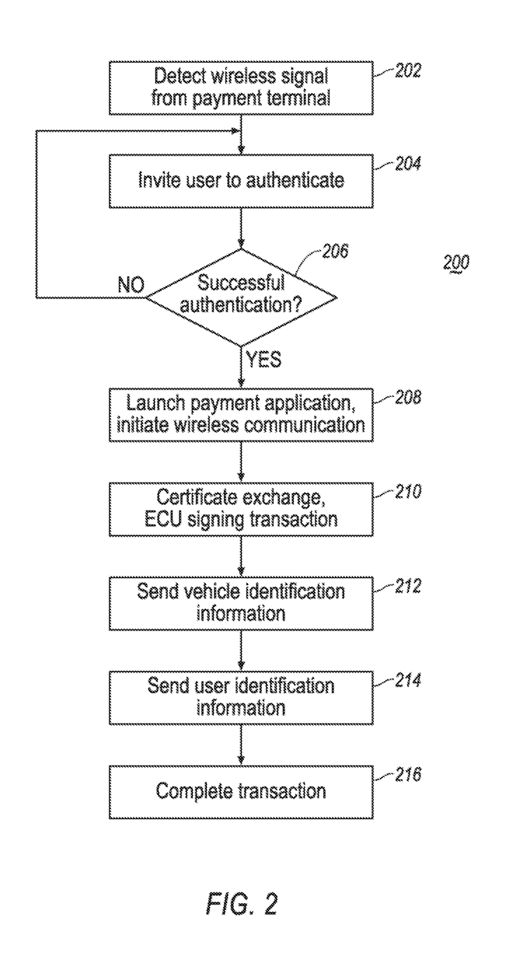

Referring to FIG. 2, an example flow diagram for a process 200 for wireless payment is illustrated. With continuing reference to FIG. 1, in this example, the process 200 may be performed on the computing platform 104 of the vehicle 102. Alternatively, the process 200 may be performed on the mobile device 140 of the user of the vehicle 102. Alternatively, the process 200 may be divided and some aspects may be performed on the computing platform 104 while other aspects may be performed on the mobile device 140. For the simplicity of illustration, the process 200 described herein will be performed on the computing platform 104.

The process 200 begins at operation 202. At 202, the wireless transceiver 132 of the computing platform 104 detects a wireless payment signal transmitted from the wireless payment terminal 170. The wireless payment signal may be any type of signal that the computing platform supports. For instance, the wireless signal may be a NFC, WiFi, RFID, BLUETOOTH signal or other types signal.

Responsive to the detection of the wireless signal, at operation 204, the computing platform 104 invites the user to authenticate a wireless communication with the wireless payment terminal 170. For instance, the computing platform 104 may output a visual message using the display 116 and/or an audio message using the speaker 122 via the HMI controls 118 to invite the user to authenticate the wireless communication. As an example, the authentication may be performed by user inputting a personal identification number (PIN) via the HMI controls 118. Additionally or alternatively, the authentication may be made using biometric information such as fingerprint or facial recognition. The computing platform 104 may be provided with biometric sensors such as a fingerprint reader and/or a camera (not shown) to input biometric information of a user for authentication purposes. At operation 206, if the computing platform 104 determines the authentication fails, the process returns to operation 204 and the computing platform 104 invites the user to authenticate again. Responsive to a successful authentication, the process proceeds to operation 208.

At operation 208, the computing platform 104 launches the payment application stored in the storage 106 (one of the vehicle applications 108) and establish the wireless connection 166 to initiate the communication with the compatible wireless transceiver 188 of the payment terminal 170.

In order to enhance the security of the wireless communication with the payment terminal 170, at operation 210, the computing platform 104 performs security certificate exchange and ECU signing the transaction with the payment terminal 170 to ensure that the transaction originates from the vehicle 102. As an example, the computing platform 104 may use a serial number of one of the ECUs 138 for authentication purposes. Since each ECU 38 has a unique serial number, authenticating the transaction using the serial number may guarantee that the transaction originates from the correct vehicle 102.

At operation 212, the computing platform 104 transmits vehicle identification information to the wireless payment terminal 170. As an example, the vehicle identification information may include information such as a vehicle identification number (VIN), vehicle year, brand, model, color and etc.

At operation 214, the computing platform 104 further transmits user identification information to the wireless payment terminal 170. For instance, the user identification information may include a picture of the user. Using the vehicle identification information and the user identification information, operators of the wireless payment terminal 170 may visually inspect the parties of the transaction, further enhancing the security.

At operation 216, the processes completes responsive to a successful payment transaction.

The operation of the process 200 may be applied to various situations. In one example, a user pulls his vehicle 102 up to a drive-through retailer (e.g. McDonald®) which is equipped with the wireless payment terminal 170. Responsive to detecting a wireless signal transmitted from the payment terminal 170, the computing platform 104 invites the user to authenticate to establish a wireless connection 166 for wireless payment. The wireless signal from the payment terminal 170 may be transmitted by means of Bluetooth, NFC, RFID, WiFi or other short-range communication. In general, short range communication is preferred because it may help avoid the terminal 170 transmitting the signal to vehicles 102 that are not intending to proceed with the wireless transactions.

It is noted that for security reasons, the wireless connection 166 is not established at this point because the user authentication has not been received. This feature may further prevent unauthorized persons from using the payment system. If the user (e.g. the owner of the vehicle 102) is authorized and wishes to use the wireless payment system to proceed with the payment transaction, he/she may choose to authenticate to launch the wireless payment application stored in the storage 106 (one of the vehicle applications 108) to establish the wireless connection 166. As discussed above, the authentication may be performed using a PIN code or biometric information such as a fingerprint or facial recognition. Alternatively, the authentication may be performed using the mobile device 140 of the user connected to the computing platform 104 via the wireless connection 142. Since many mobile devices 140 (e.g. a smart phone) are equipped with a touch screen, a front-facing camera and/or a fingerprint reader, performing authentication via the mobile device 140 may be easier and more convenient than doing it via the HMI controls 118 of the computing platform 104.

Responsive to a successful authentication indicative of the user being authorized to use wireless payments, the computing platform 104 launches the payment application and establishes the wireless connection 166 to the payment terminal 170. The transaction information may be transmitted between the vehicle 102 and the payment terminal 170 via the wireless connection 166. For instance, the transaction information may include payment amount, payment certificate, account information, and/or other authentication information. After the user finishes his/her order from the drive-through retailer, the payment terminal 170 may provide a total amount to be paid to the computing platform 104 via the wireless connection 166. The total amount may be displayed on the display 116 or the screen of the mobile device 140. Responsive to the user input authorizing the payment, the computing platform 104 proceeds with the transaction by exchanging a digital security certificate and signing the transaction using a ECU information to the payment terminal 170. Alternatively, the security certificate exchange may be performed earlier responsive to the establishment of the wireless connection 166.

The computing platform 104 may further send a vehicle identification information to the terminal 170. For instance, the vehicle identification information may include one or more of a VIN, make, model, and/or color of the vehicle 102. The vehicle identification information may help the shop employee operating the payment terminal 170 identify and visually verify the vehicle 102 processing the transaction to prevent fraud. This may also be helpful when there are multiple vehicles 102 pulling to a drive through processing the wireless transaction at the same time. The employee may more easily identify the vehicle 102 so as to reduce the likelihood of mistakes. Additionally, the computing platform 104 may further transmit a user identification information to the terminal 107 to provide extra security. For instance, the user identification information may include a picture of the user to assist the shop employee to verify the identity of the person who is making the purchase. Alternatively, the payment terminal may be equipped with a camera (not shown) and facial recognition capabilities. As an example, the payment terminal may ask the user to look at the camera and capture the facial image of the person in the vehicle 102 making the purchase, and compare the facial image with the picture the authorized user to verify his/her identity.

Responsive to a successful verification of the identity of both the vehicle 102 and the user by the shop employee or the terminal 170, the process 200 may proceed with the transaction by sending the digital payment and authorization information to a remote server 190. The server 190 may be operated by the bank which issues the credit card or account to the authorized user. The digital certificate and the ECU signature transmitted from the vehicle 102 may be previously registered with the bank and stored in the server 190. Therefore, the payment information verification may be performed at the server 190. Responsive to a successful verification, the server 190 may proceed with the transaction and send an approval message to the payment terminal 170, which in turn transmits the approval message to the vehicle 102 to notify about the success of the transaction. The vehicle 102 may notify the approval of the transaction by outputting a visual message via the display 116 and/or an audio message via the speaker 122.

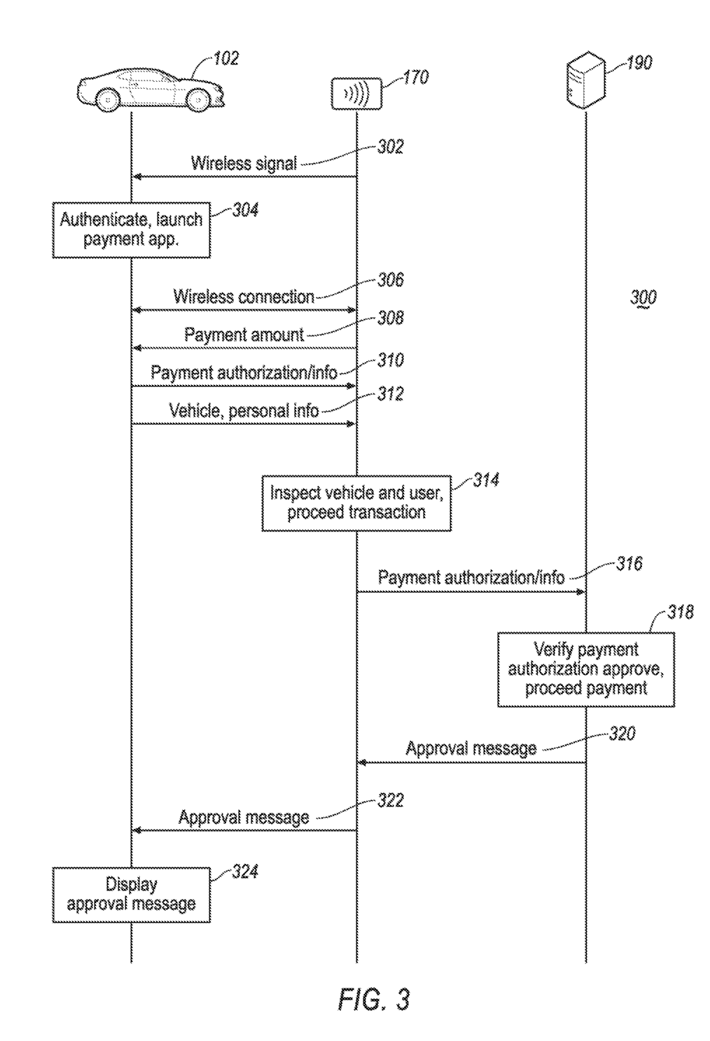

Referring to FIG. 3, an example data flow diagram for a process 300 for wireless payment is illustrated. With continuing reference to FIG. 1, at operation 302 the payment terminal 170 to the vehicle 102 which is within the transmission range of the terminal 170. In response, at operation 304, the vehicle 102 invites the user to authenticate to launch the payment application and connect to the terminal. As discussed above, the authentication may be performed using a PIN or biometric information. Responsive to a successful authentication, the vehicle 102 launches the payment application and establish the wireless connection 166 with the terminal 170.

At operation 308, the terminal 170 sends the payment amount to the vehicle 102. In response, at operation 310, the user of the vehicle 102 authorizes the payment and sends the payment authorization and information to the terminal 170. For instance, the payment authorization and information may include an account of the user, a digital security certificate and/or a ECU signature of the vehicle 102. At operation 312, the vehicle 102 sends the vehicle identification information and the personal identification information to the terminal. For instance, the vehicle identification information may include one or more of a VIN, registration number, make, model, and/or color of the vehicle 102. Alternatively, the vehicle 102 may only send the VIN of the vehicle 102 and the terminal 170 may be configured to obtain other information of the vehicle 102 from the cloud. The personal identification information may include the picture of the user. At operation 314, a shop employee operating the payment terminal 170 may visually inspect the vehicle and the person making the purchase and decide to proceed with the transaction if the information matches.

At operation 316, the terminal 170 sends the payment authorization and information to the remote server 190 to verify. At operation 318, the remote server 190 verifies the payment authorization and information, and responsive to a successful verification, proceed with the payment transaction. At operation 320 the server 190 sends an approval message to the terminal 170, which in turn sends the approval message to the vehicle 102 at operation 322. At operation 324, the vehicle 102 displays the approval message to notify the user of a successful transaction.

One advantage of the present disclosure is that a more secure wireless payment technical solution is provided. Due to the nature of wireless transactions, other unwanted parties may receive the wireless signals between the vehicle 102 and the payment terminal 170 and therefore to intercept the transaction. By using the PIN, digital certificate, ECU signature and/or vehicle/personal identification information, the security of the wireless transactions may be greatly enhanced. In addition, the present disclosure provides a more convenient solution for vehicle 102 and the terminal 170 to engage in wireless transactions.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle system, comprising:
a processor programmed to
responsive to a successful authentication of a user, launch a payment application and establish a wireless communication with a payment terminal;
exchange a security certificate with the payment terminal; and
authorize a transaction by transmitting transaction information including ECU information to the payment terminal.

2. The vehicle system of claim 1, wherein the authentication of the user is performed by authenticating at least one of: a personal identification number (PIN) or a biometric factor.

3. The vehicle system of claim 2, wherein the biometric factor includes at least one of: fingerprint information or facial recognition information.

4. The vehicle system of claim 1, wherein the processor is further programmed to send a vehicle identification information to the payment terminal.

5. The vehicle system of claim 4, wherein the vehicle identification information includes at least one of: a vehicle identification number (VIN), vehicle registration, vehicle year, vehicle make, vehicle model, or vehicle color.

6. The vehicle system of claim 1, wherein the processor is further programmed to send a user information to the payment terminal.

7. The vehicle system of claim 6, wherein the user information includes a picture of the user.

8. The vehicle system of claim 1, wherein the processor is further programmed to communicate with a mobile device and receive the authentication of the user from the mobile device.

9. The vehicle system of claim 1, wherein the processor is further configured to, responsive to detecting a wireless signal transmitted from the payment terminal, invite the user to authenticate.

10. A payment terminal, comprising:
a processor programmed to
establish a wireless connection to a digital entity responsive to a successful authentication of a user on the digital entity;
exchange security certificate with the digital entity;
receive a payment authorization including an ECU signature from the digital entity;
send the payment authorization to a server; and
receive an approval from the server.

11. The payment terminal of claim 10, wherein the digital entity is a vehicle.

12. The payment terminal of claim 10, wherein the digital entity is a mobile device associated with a vehicle.

13. The payment terminal of claim 10, wherein the processor is further programmed to receive a vehicle identification information from the digital entity.

14. The payment terminal of claim 13, wherein the vehicle identification information includes at least one of: a vehicle identification number (VIN), vehicle registration, vehicle year, vehicle make, vehicle model, or vehicle color.

15. The payment terminal of claim 10, wherein the processor is further programmed to receive a user identification information from the digital entity.

16. The payment terminal of claim 15, wherein the user information includes a picture of the user.

17. The payment terminal of claim 16, wherein the processor is further programmed to
receive an image of the user captured by a camera; and
perform facial recognition using the picture and the image of the user.
